(19) United States
(12) Patent Application Publication
(10) Pub. No.: US 2010/0129533 A1
(43) Pub. Date: May 27, 2010

(54) Conductive Film Formation On Glass

(76) Inventors: Dilip Kumar Chatterjee, Rochester, NY (US); Curtis Robert Fekety, Tioga, PA (US); Zhen Song, Painted Post, NY (US); Ji Wang, Painted Post, NY (US)

Correspondence Address: CORNING INCORPORATED, SP-TI-3-1, CORNING, NY, 14831, US

(21) Appl. No.: 12/275,328

(22) Filed: Nov. 21, 2008

(51) Int. Cl. B05D 5/12

(52) U.S. Cl. 427/110

(57) ABSTRACT

Methods for coating a glass substrate are described. The coatings are conductive metal oxide coatings which can also be transparent. The conductive thin film coated glass substrates can be used in, for example, display devices, solar cell applications and in many other rapidly growing industries and applications.

### BACKGROUND

1. Field of the Invention

Embodiments of the invention relate to methods for coating a substrate and more particularly to methods for coating a glass substrate with a conductive thin film.

2. Technical Background

Transparent and electrically conductive thin film coated glass is useful for a number of applications, for example, in display applications such as the back plane architecture of display devices, for example, liquid crystal displays (LCD), and organic light-emitting diodes (OLED) for cell phones. Transparent and electrically conductive thin film coated glass is also useful for solar cell applications, for example, as the transparent electrode for some types of photovoltaic cells and in many other rapidly growing industries and applications.

Conventional methods for coating glass substrates typically include vacuum pumping of materials, cleaning of glass surfaces prior to coating, heating of the glass substrate prior to coating and subsequent depositing of specific coating materials.

Typically, deposition of conductive transparent thin films on glass substrates is performed in a vacuum chamber either by sputtering or by chemical vapor deposition (CVD), for example, plasma enhanced chemical vapor deposition (PECVD), spray coating, or metal vapor deposition followed by oxidation. With the exception of spray coating, these coating processes are high cost processes. They either typically operate in vacuum or use expensive precursors. Spray coating is cost effective, but usually results in nonuniform coating with defect sites on the coated films.

Sputtering of conductive transparent thin films on glass, for example, sputter deposition of indium doped tin oxide on glasses, has one or more of the following disadvantages: large area sputtering is challenging, time consuming, and generally produces non-uniform films on glass substrates, especially glass substrates of increased size, for example, display glass for televisions.

The glass cleaning prior to coating in several conventional coating methods introduces complexity and additional cost. Also, several conventional coating methods require a doping of the coating which is typically difficult and introduces additional processing steps.

It would be advantageous to develop a method for coating a glass substrate with a transparent conductive thin film while increasing coating density and/or minimizing morphology variations evident in conventional coating methods while reducing manufacturing cost and manufacturing time. It would also be advantageous to form conductive films at ambient pressure as opposed to forming conductive films in a vacuum.

### SUMMARY

Methods for coating a glass substrate with a conductive thin film as described herein, address one or more of the above-mentioned disadvantages of the conventional coating methods, in particular, when the coating comprises a metal oxide.

In one embodiment, a method for making a conductive film is disclosed. The method comprises providing a solution comprising a metal halide and a solvent, preparing aerosol droplets of the solution, and applying the aerosol droplets to a heated glass substrate, converting the metal halide to its respective oxide to form a conductive film on the glass substrate.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawings.

FIG. 1A is a graph of an exemplary aerosol droplet size distribution.

FIG. 1B is a graph of an exemplary dried particle size distribution.

FIG. 2A is a scanning electron microscope (SEM) image of a conductive film made according to one embodiment.

FIG. 2B is a cross sectional SEM image of a conductive film made according to one embodiment.

FIG. 3A is a SEM image of a conductive film made according to one embodiment.

FIG. 3B is a cross sectional SEM image of a conductive film made according to one embodiment.

FIG. 4A is a SEM image of a conductive film made according to one embodiment.

FIG. 4B is a cross sectional SEM image of a conductive film made according to one embodiment.

### DETAILED DESCRIPTION

Reference will now be made in detail to various embodiments of the invention, an example of which is illustrated in the accompanying drawings.

In one embodiment, a method for making a conductive film is disclosed. The method comprises providing a solution comprising a metal halide and a solvent, preparing aerosol droplets of the solution, and applying the aerosol droplets to a heated glass substrate, converting the metal halide to its respective oxide to form a conductive film on the glass substrate.

Hydrolysis reactions are possible when the solvent comprises water. In these reactions, the metal halide reacts with water and converts to its respective oxide. When the solvent comprises only alcohol, a flash reaction can occur in the presence of oxygen where the alcohol is evaporated and/or combusted. The metal halide reacts with the oxygen in an oxidation reaction to form its respective oxide. In one embodiment, the oxide sinters to form a conductive film. The conductive film is transparent in some embodiments.

According to one embodiment, the solvent comprises a material selected from water, an alcohol, a ketone and combinations thereof. In some embodiments, the solvent is selected from ethanol, propanol, acetone and combinations thereof. Other useful solvents are solvents in which the metal halide is soluble.

The metal halide, in one embodiment, is selected from SnCl₄, SnCl₂, SnBr₄, ZnCl₂ and combinations thereof. The metal halide can be in an amount of from 5 to 20 weight percent of the solution, for example, 13 weight percent or more of the solution.

In some embodiments, the solution further comprises a dopant precursor. The dopant precursor can be selected from HF, NH₄F, SbCl₃, and combinations thereof, for example.

According to one embodiment, preparing aerosol droplets comprises atomizing the solution. Atomizing the solution, according to one embodiment, comprises flowing a gas selected from argon, helium, nitrogen, carbon monoxide, hydrogen in nitrogen and oxygen through the solution in an atomizer. According to another embodiment, atomizing the solution comprises flowing ambient air through the atomizer. In some embodiments, the velocity of the atomized solution can be between 2 liters per minute(L/min) and 7 L/min, for example, 3 L/min. The aerosol droplets, in one embodiment, have a droplet size of 4000 nanometers or less in diameter, for example, a droplet size of from 10 nanometers to 1000 nanometers, for example, 50 nanometers to 450 nanometers.

Applying the aerosol droplets, according to one embodiment, comprises spraying the aerosol droplets from one or more sprayers adapted to receive the aerosol droplets from the atomizer and located proximate to the glass substrate.

The aerosol sprayer can be of any shape depending on the shape of the glass substrate to be coated and the area of the glass substrate to be coated. Spraying the aerosol droplets can comprise translating the sprayer(s) in one or more directions relative to the glass substrate, for example, in an X direction, a Y direction, a Z direction or a combination thereof in a three dimensional Cartesian coordinate system.

In one embodiment, the glass substrate is in a form selected from a glass sheet, a glass slide, a textured glass substrate, a glass sphere, a glass cube, a glass tube, a honeycomb, and a combination thereof.

According to one embodiment, the method comprises applying the aerosol droplets to the glass substrate that is at a temperature of from 295 degrees Celsius to 600 degrees Celsius, for example, at a temperature of from 350 degrees Celsius to 420 degrees Celsius. In some applications, the upper end of the temperature range is dependent on the softening point of the glass substrate. The conductive films are typically applied at a temperature below the softening point of the glass substrate. According to one embodiment, the conductive film is formed at ambient pressure.

In one embodiment, the conductive film comprises Cl doped SnO₂, F and Cl doped SnO₂, F doped SnO₂, Sn doped In₂O₃, Al doped ZnO, Cd doped SnO₂, or combinations thereof.

The conductive thin film, in one embodiment, has a thickness of 2000 nanometers or less, for example, 10 nanometers to 1000 nanometers, for example, 10 nanometers to 500 nanometers.

A photovoltaic device, a display device, or an organic light-emitting diode can comprise the conductive thin films made according to the disclosed methods.

Evaporation of the solvent in the aerosol droplets can occur during transportation and/or deposition of the aerosol droplets onto the substrate. Evaporation of the solvent, in some embodiments can occur after the aerosol droplets have been deposited onto the substrate. Several reactive mechanisms can be realized by the disclosed methods, for example, a homogeneous reaction between the metal halide and the solvent in the aerosol droplets, a heterogeneous reaction between the solvent and/or the gas with the oxide in the formed or forming oxide(s), and/or oxide nucleus bonding with surface of the substrate and crystallization.

By controlling the aerosol transportation temperature, evaporation of the solvent from the aerosol droplets can be controlled and thus, the mean aerosol droplet size can be controlled to make the deposition more efficient and/or more uniform. Controlling the transportation temperature can enhance reactions between solvent and metal halide, and the formation of solid nuclei inside the droplets.

Heating the glass substrate can provide enough activation energy for the formation of oxides. Meanwhile the remaining solvent evaporates from the heated glass substrate. Heating can also provide energy for the deposited small particles to crystallize and form bigger crystals.

In one embodiment, providing the solution comprises dissolving precursors for the oxide(s) and/or the dopant(s) into a solvent. For example, to prepare a SnO₂ based transparent conductive oxide (TCO) film, SnCl₄ and SnCl₂ can be used as Sn precursors. HF, NH₄F, SbCl₃, etc. can be used as F and Sb dopant precursors. The solvent for these precursors can be water or alcohol such as ethanol, propanol, etc., or any other solvent that can dissolve these precursors, or the combinations of these solvents. Different solvents can lead to different surface adhesive rates, different evaporation rates and different chemical reactions. When using water as the solvent, SnCl₂ or SnCl₄ as the precursor to make SnO₂, the SnCl₂ or SnCl₄ is hydrolyzed by water and this reaction occurs in solution, in droplets and on the deposited surface. The produced HCl enhances the fully oxidation of Sn by water. The dopants (such as F and Sb) can be added into the SnO2 lattice during the deposition process. The remnant Cl on Sn can also remain in the lattice and form Cl doping.

### EXAMPLES

A solution was provided by combining 0.27M SnCl₄ and deionized water. The SnCl₄ was hydrolyzed by the water to form HCl. The resulting solution was acidic with a pH value of approximately 0.5. The solution was atomized with a TSI 9306 jet atomizer with flowing nitrogen gas with a pressure of 30 pounds per square inch (psi) using two of the available six jets to form the aerosol droplets. To minimize the etching of the atomizer by the strong acidic solution, the metal parts in the atomizer reservoir and nozzle were replaced by plastic. Glass substrates were placed in the center of the three inch quartz tube of the tube furnace horizontally. This design enabled a laminar flow of the aerosol droplets across the surface of the glass substrates. The laminar flow is believed to enhance the coating uniformity, as well as increase the coating rate. The tube furnace heated the glass substrates as well as the aerosol droplets generated by the atomizer. For SnO₂ coating, the tube furnace was set at a temperature of 350° C. Additional glass substrates were coated with SnO₂ when the tube furnace was set at a temperature of 370° C. Glass substrates can be coated, for example, for times ranging from 15 minutes to 90 minutes. In this example, the glass substrates coated at 350° C. were coated for 30 minutes and the glass substrates coated at 370° C. were coated for 60 minutes. The coated glass substrates remained in the tube furnace set at their respective deposition temperatures for 30 minutes with the nitrogen gas flowing for the 30 minutes. The resulting conductive films were from 100 to 1000 nanometers in thickness.

During the deposition of the aerosol droplets the following hydrolysis reaction occurred:

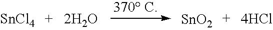

Cl was also doped into SnO₂ lattice. If other dopants co-exist in the solution, such as HF, NH₄F or SbCl₃, F or Sb, the dopants can also be incorporated into the SnO₂ lattice. This doping helps to form a stable conductive film.

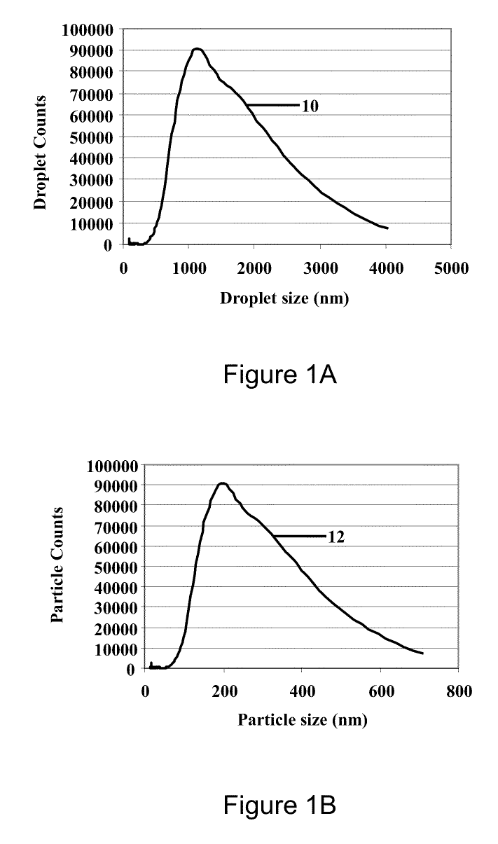

An exemplary aerosol droplet size distribution is shown by line 10 in FIG. 1A and an exemplary corresponding dried particle size distribution is shown by line 12 in FIG. 1B. The particle size distribution can be estimated from the aerosol droplet size distribution.

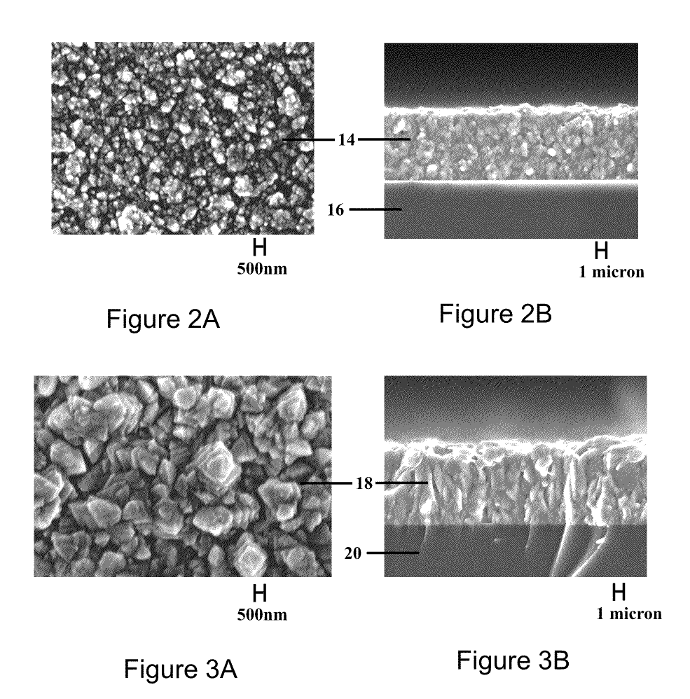

FIG. 2A and FIG. 2B show SEM images of the Cl doped SnO₂ conductive film 14 formed on the glass substrate 16 in the tube furnace at 350° C. Since, 350° C. is lower than the crystallization temperature for SnO₂, the SnO₂ particles in the film reflect the particles in the aerosol droplets.

FIG. 3A and FIG. 3B show SEM images of the Cl doped SnO₂ conductive film 18 formed on the glass substrate 20 in the tube furnace at 370° C. At 370° C., the SnO₂ particles crystallize. Crystallization may be affected by the substrate temperature and/or the remaining liquid phase from the aerosol droplets.

The conductive films were analyzed using X-ray diffraction (XRD). The measurements confirmed the different crystalline structures between the conductive films shown in FIGS. 2A and 2B and those shown in FIGS. 3A and 3B. The XRD shows that the 370° C. deposited films have higher crystallinity and preferred [100] orientation. The XRD patterns and peak intensities of the 350° C. deposited films are similar to those of SnO₂ powders and do not have preferred orientation. Films showing higher crystallinity may possess better conductivity.

Electronic measurements were taken for both the 350° C. deposited films and the 370° C. deposited films. The 370° C. deposited films were found to have higher conductivity than the 350° C. deposited films. The 370° C. deposited film having a thickness of 400 nanometers was found to have a sheet resistance of 50 Ω/□, and a resistivity of 2×10⁻³ Ω.cm.

The transparencies of the Cl doped SnO₂ films were measured by transmittance spectrometry. An exemplary Cl doped SnO₂ film having a thickness of 500 nanometers had greater than 80% transparency in the 400 nanometer to 1000 nanometer wavelength range.

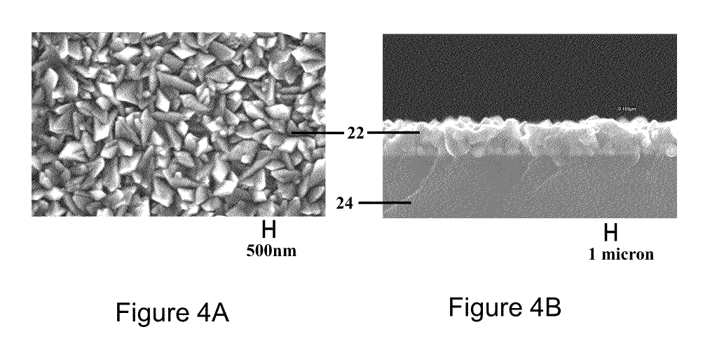

F and Cl co-doped SnO₂ conductive films were prepared by using SnCl₄ and HF as precursors. The solution was prepared by combining 0.27M SnCl₄ and deionized water and different amounts of HF. In this example, F/Sn molar ratios of from 0.7 to 0.37 were prepared. The tube furnace was set at a temperature of 370° C. and the deposition time was 15 minutes. FIG. 4A and FIG. 4B show SEM images of a F and Cl co-doped SnO₂ conductive film 22 on a glass substrate 24 prepared with a 0.22 molar ratio of F/Sn solution. The SnO₂ was found to be crystalline. The film thickness was from 100 nanometers to 200 nanometers.

Secondary Ion Mass Spectrometry (SIMS) measurements of the F and Cl co-doped SnO₂ film were taken and confirmed the F and Cl dopants in the SnO₂ matrix.

The F and Cl co-doped SnO₂ film sheet resistance was 60 Ω/□, and the resistivity was 8×10⁻⁴ Ω.cm. for a film 140 nanometers in thickness. The most conductive film was prepared using a 3:2 molar ratio of F/Sn in about 0.5M the SnCl₄ precursor solution.

The F and Cl co-doped SnO₂ film, made using a F/Sn mole ratio of 0.30 and 0.37 in the precursor solution, transparency was measured by VIS-NIR transmittance. The F and Cl co-doped SnO₂ film 150 nanometers in thickness had a transparency of about 90% in the 400 to 700 nanometer wavelength.

According to one embodiment, the method further comprises heat treating the conductive film after forming the conductive film. The heat treatment can be performed in air at temperatures ranging form less than 250° C., for example, from 150° C. to 250° C., for example 200° C. Heat treating can be performed in an inert atmosphere, for example, in nitrogen which may allow for higher heat treating temperatures, for example, greater than 250° C., for example, 400° C.

The conductivity of the conductive films can be further improved by post heat treatment. This heat treatment can remove the adsorbates from the grain boundaries and the particle surfaces, and releases the trapped free electrons. The post treatment temperature should be below the SnO₂ oxidation temperature, if the treatment is in air. A temperature of 200° C. was found to be an advantageous post treatment temperature in air. Cl doped SnO₂ films of several kΩ can be improved to several hundreds Ω after this post treatment. F and Cl co-doped SnO₂ films of several hundreds Ω can be lowered to tens of Ω, for example, a 150 nanometer film had the sheet resistance of 60 Ω/□ after being heat treated in air at 200° C. for 30 minutes. This resulted in a film with resistivity of 9×10⁻⁴ Ω.cm.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for making a conductive film, the method comprising:
providing a solution comprising a metal halide and a solvent;
preparing aerosol droplets of the solution; and
applying the aerosol droplets to a heated glass substrate, converting the metal halide to its respective oxide to form a conductive film on the glass substrate.

2. The method according to claim 1, wherein the solvent comprises a material selected from water, an alcohol, a ketone and combinations thereof.

3. The method according to claim 2, wherein the solvent is selected from ethanol, propanol, acetone and combinations thereof.

4. The method according to claim 1, wherein the conductive film is transparent.

5. The method according to claim 1, wherein the metal halide is selected from SnCl₄, SnCl₂, SnBr₄, ZnCl₂ and combinations thereof.

6. The method according to claim 1, wherein the solution further comprises a dopant precursor.

7. The method according to claim 6, wherein the dopant precursor is selected from HF, NH₄F, SbCl₃, and combinations thereof.

8. The method according to claim 1, wherein the solution comprises the metal halide in an amount of from 5 to 20 weight percent of the solution.

9. The method according to claim 1, wherein the solution comprises the metal halide in an amount of 13 weight percent or more of the solution.

10. The method according to claim 1, wherein the aerosol droplets have a droplet size of 4000 nanometers or less in diameter.

11. The method according to claim 1, wherein preparing aerosol droplets comprises atomizing the solution.

12. The method according to claim 11, wherein applying the aerosol droplets comprises spraying the aerosol droplets from one or more sprayers adapted to receive the aerosol droplets from the atomizer and located proximate to the glass substrate.

13. The method according to claim 12, further comprising translating the one or more sprayers in one or more directions relative to the glass substrate.

14. The method according to claim 12, wherein atomizing the solution comprises flowing a gas selected from argon, helium, nitrogen, carbon monoxide, hydrogen in nitrogen and oxygen through the atomizer.

15. The method according to claim 1, wherein the glass substrate is in a form selected from a glass sheet, a glass slide, a textured glass substrate, a glass sphere, a glass cube, a glass tube, a honeycomb, and a combination thereof.

16. The method according to claim 1, which comprises applying the aerosol droplets to the glass substrate that is at a temperature of from 295 degrees Celsius to 600 degrees Celsius.

17. The method according to claim 16, which comprises applying the aerosol droplets to the glass substrate that is at a temperature of from 350 degrees Celsius to 420 degrees Celsius.

18. The method according to claim 1, wherein the conductive film comprises Cl doped SnO₂, F and Cl doped SnO₂, F doped SnO₂, Sn doped In₂O₃, Al doped ZnO, Cd doped SnO₂, or combinations thereof.

19. A photovoltaic device, a display device, or an organic light-emitting diode comprising the conductive thin film made according to claim 1.

20. The method according to claim 1, wherein the conductive thin film has a thickness of 2000 nanometers or less.

21. The method according to claim 1, further comprising heat treating the conductive film after forming the conductive film.

22. The method according to claim 1, wherein the conductive film is formed at ambient pressure.
